(19) United States
(12) Patent Application Publication
(10) Pub. No.: US 2009/0012917 A1
(43) Pub. Date: Jan. 8, 2009

(54) System and Method for Array and String Level Monitoring of a Grid-Connected Photovoltaic Power System

(75) Inventors: Daniel S. Thompson, San Rafael, CA (US); Laks Sampath, Corte Madena, CA (US); David Shevick, San Rafael, CA (US)

Correspondence Address: STAINBROOK & STAINBROOK, LLP, 412 AVIATION BOULEVARD, SUITE H, SANTA ROSA, CA, 95403, US

(73) Assignee: THOMPSON TECHNOLOGY INDUSTRIES, INC., NOVATO, CA (US)

(21) Appl. No.: 12/088,978

(22) PCT Filed: Oct. 4, 2006
(86) PCT No.: PCT/US2006/039069

§ 371 Date: Apr. 2, 2008

Related U.S. Application Data
(60) Provisional application No. 60/732,421, filed on Oct. 31, 2005.

(51) Int. Cl. G06Q 30/00; G06F 19/00; G06Q 50/00; G06F 3/048; G08B 23/00

(52) U.S. Cl. 705/412; 700/286; 715/772; 700/297; 340/657

(57) ABSTRACT

A grid-connected photovoltaic electrical power system with both array level and string level remote monitoring and production and efficiency analysis capabilities. The inventive system includes an array level monitoring component, software for recording and analyzing data obtained through the array level monitoring component, and a string level monitoring component.

### BACKGROUND OF THE INVENTION

1. Technical Field

The present invention generally relates to a grid-connected photovoltaic energy system. More specifically, the present invention relates to a grid-connected photovoltaic electrical power system with both array level and string level remote monitoring and production and efficiency analysis capabilities.

2. Background Art

As the earth's remaining reserves of oil rapidly approach depletion, as evidence of global warming from CO₂ mounts, and as awareness of the need and desirability of clean energy and the responsible conservation of natural resources increases, people are turning to renewable and reliable sources of electrical power. It is simply trite now to say that the sun is ultimate source of all energy on the earth, less so perhaps to say that the direct use of sunlight is the most promising of the proposed solutions to future electrical energy supply problems, as it is a safe and entirely reliable means of generating energy. There is, however, considerable debate about the economic viability of solar power systems, and it is essentially the economic factors alone that remain problematic for most potential users in those parts of the world where sunlight is sufficiently abundant. Even so, the installation of photovoltaic systems is on the increase, as is the design and development of buildings that optimize the use of sunlight for heating, lighting, and hot water supply. And the evaluation of photovoltaic system performance is therefore increasingly important.

Photovoltaic power systems generally include a plurality of interconnected photovoltaic modules mounted on large planar surfaces, typically the roof of the building or home to be supplied with power, but occasionally on a ground surface proximate the structures. The modules are connected in series to form a string and these interconnected strings are referred to as an array. Each photovoltaic module in the array includes photovoltaic cells that convert solar energy into DC power, and the DC power from each of the modules is combined and conveyed through a DC/AC power inverter, typically mounted proximate to the electrical power supply from a utility power provider. The inverter converts the direct current into an alternating current compatible with the alternating current provided by the utility provider (i.e., the utility grid), so that the AC output of the photovoltaic system joins the AC power from the utility provider through the building distribution panel to power the load. This kind of arrangement is described as a grid-connected photovoltaic power system (denominated a GCPV system herein).

As is immediately evident, power supplied by the GCPV system results in cost savings to consumers by reducing utility power consumption in a safe, environmentally friendly way. Furthermore, where tax and financial incentives, as well as solar rebate programs are provided by public policy and law, installation and operation costs are offset and further contribute to savings.

There are several advantages of a GCPV over a stand-alone PV system, most notably including the fact that power can be obtained at night and during inclement weather and dark winter days without the need of having and expensive battery bank for storing power. Furthermore, during peak solar power generation times, excess power can be traded back to the utilities. A disadvantage is that GCPV systems may only be installed at locations that receive power from the utility grid.

A threshold step in lowering energy costs is to reduce electrical consumption. An intelligent approach to selecting and operating a suitable PV system entails preliminary and ongoing energy audits to determine actual demand, power consumption, and power waste. Such audits can prevent customers from purchasing an excessively large PV system and can prevent waste subsequent to system installation. A preliminary audit includes an identification of the principal sources of electrical consumption, after which energy reduction and efficiency solutions are directed to problems in lighting, refrigeration, air conditioning, motor starts and optimization, and so forth. Upgrading devices, appliances, structural insulation, and the like can result in substantial, and when combined with a PV system can significantly reduce, and potentially eliminate, energy consumption from the public utility grid. Indeed, in a net metering environment, PV power users may purchase power from the utility and also trade surplus generated power back to the distribution grid for credit. In effect, on sunny days the electric meter spins backwards and the solar system earns credit for the energy at the utility's retail energy rate. Utilities are required to credit solar energy producers at the retail rate at the time of day that the energy is sent to the grid.

Once installed, the operation and efficiency of GCPV systems requires the collection, monitoring, and evaluation of large amounts of data. Several factors affect the efficiency of a GCPV system, including the electrical power output of PV system; the electrical power provided by the utility provider (as contributing or exclusive source); the electrical power consumption of the user; and operating environment data such as ambient temperature, wind speed and direction, solar irradiance, and solar insolation.

What is true for GCPV systems equally applies to power generated and sold under a power purchase agreement.

Many institutions, industries, and governments are moving towards “green power” procurement as part of their energy strategy. The term in quotes refers, of course, to a number of renewable energy sources besides solar, most notably including wind power. Government, industry, and even individuals can now purchase all or a portion of their electrical power under long-term and short term power purchase agreements, either directly from green power producers, or alternative from utility providers that procure power from green producers. Depending on local and state regulation and tax incentives, such purchases can result in the purchaser receiving credit for purchase of electricity from a renewable energy producer. Valuable emission credits and public goodwill connected with the use of renewable energy is a strong incentive to purchasing green power, and green power procurement also improves energy infrastructure reliability and reduces concern over supply disruptions potentially caused by fossil fuel shortages, production facility accidents, or (sadly) terrorism. However, power purchase agreements are contracts that often lock in a price or limited price range, and so they require the parties to forecast the future in order to strike the best deal. This is increasingly difficult to do. It is thus desirable to have some flexibility in crafting such agreements and to include performance provisions that affect purchase price. System performance, however, must then be carefully monitored, and system monitoring becomes desirable not just to the retail purchaser, but to the independent power producer and to the utility provider.

Accordingly, there exists a need for a monitoring system that enables the user and/or provider to collect, collate, and remotely analyze renewable power production system data in real time, whether that power is generated by a solar, biomass, geothermal, wind, or hydroelectric power system. The system of the present invention addresses that need.

### DISCLOSURE OF INVENTION

The method and apparatus for array and string level monitoring of a grid-connected PV system of the present invention includes three primary components: an array level monitoring system; software for recording and analyzing data obtained through the array level monitoring system; and a string level monitoring system.

The first component is an array level monitoring system that provides means for remote monitoring of the performance of a PV system. It provides real time monitoring of up to four kinds of information: (a) the electrical power output of the solar arrays; (b) the electrical power consumption of the user (building, residence, factory, etc.); and (c) electrical power provided by the power utility; and, optionally, (d) selected meteorological and solar insolation data. The system is preferably Internet based and accessible online to enable remote verification of system performance, energy cost savings, and return on investment. It will be appreciated that a number of other suitable communications systems could be employed for data transfer, including cellular communications systems, satellite systems, RF systems, infrared systems, wireless LANS and WANS, and other systems presently existing and yet to be developed.

The inventive monitoring system combines proprietary software and hardware developed by the present inventors. In operation, live, real-time solar energy data are acquired by revenue-grade ANSI electric meters and selective spectrum, silicone pyranometers or other temperature sensor. The data are delivered instantaneously online and/or to an on-site touchscreen. The data on power flow, accumulated energy usage, solar insolation, and selected meteorological conditions—such as solar irradiance, wind speed, and ambient temperature—are updated and stored at 15-minute intervals. Access to the stored data via the Internet is uninterrupted, twenty-four hours a day, 365 days a year, for both the system provider and for the user. Data downloads are provided in well-known spreadsheet format, and daily, monthly, and yearly data totalizers are also provided. All data are logged to a secure server owned, supported, and protected by the vendor.

Using the array level monitoring system of the present invention, PV system users can login to the secure server to retrieve reports on system performance, Because the monitor measures actual solar power production as well as building electrical consumption, it shows whether energy is being sent to or drawn from the utility grid in the net metering process, and this adds a layer of information and accountability not currently provided in the solar energy industry.

The second component of the inventive system is recording analysis software associated with the array level monitoring system which enables the user to log in and to perform analysis on the data acquired by the monitoring system.

The third component of the inventive system is a PV string level monitoring system that enables the monitoring of large solar rays down to the string level. Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the national patent office(s) and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a schematic diagram of a typical grid-connected PV system configuration;

FIG. 2 is a schematic diagram of the back end of the array level monitoring component of the inventive system and method for array and string level monitoring of a grid-connected photovoltaic power system;

FIG. 3 is a schematic block diagram of the string level monitoring component of the inventive system;

FIG. 4 is a schematic interconnect and functional block diagram showing the string level sensing devices of the string level monitoring component;

FIG. 5 is a schematic diagram of a preferred embodiment of a sensor board for the present invention; and

FIG. 6 is a schematic diagram of a preferred embodiment of the micro-controller board for the present invention.

The invention will be better understood and objects other than those set forth above will become apparent when consideration is given to the following detailed description thereof. Such description makes reference to the annexed drawings wherein:

### BEST MODE FOR CARRYING OUT THE INVENTION

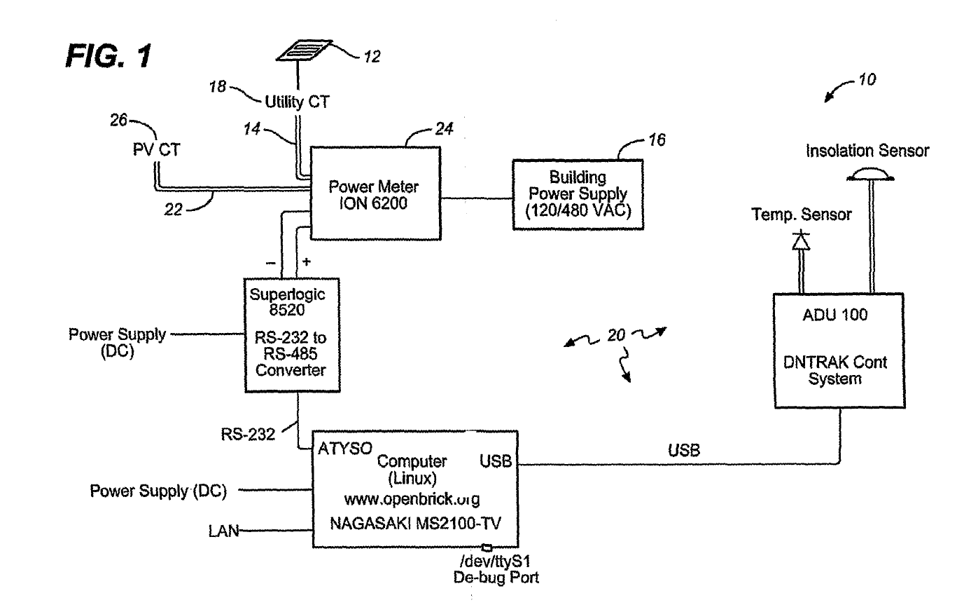

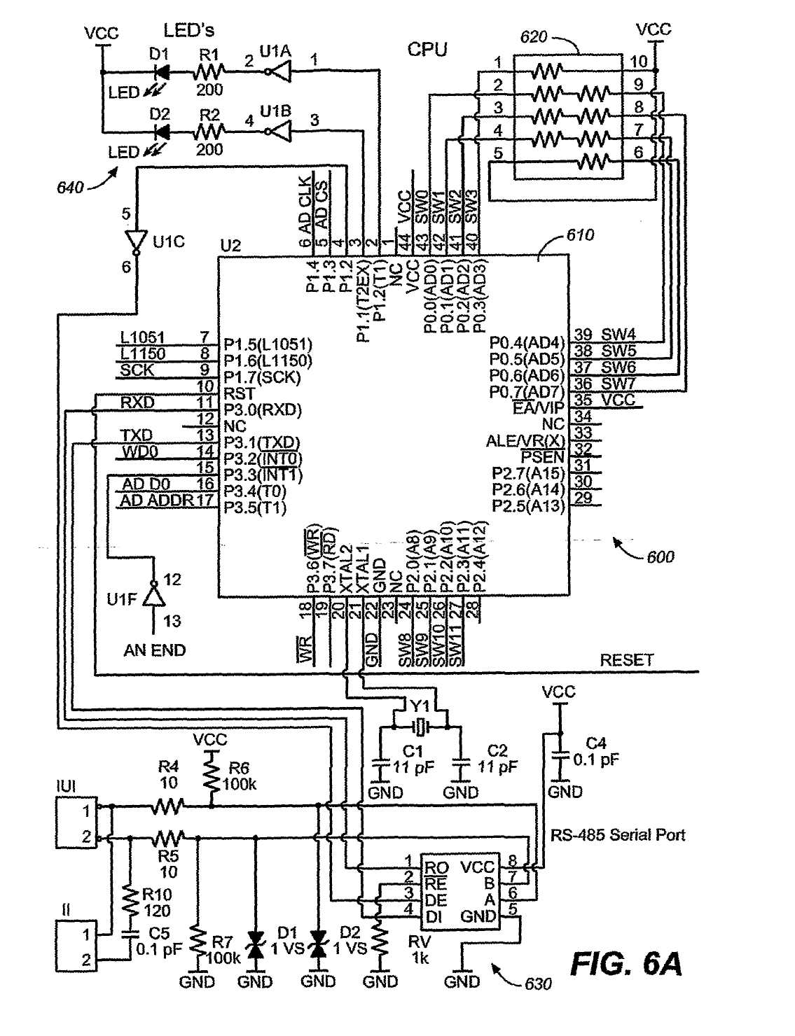

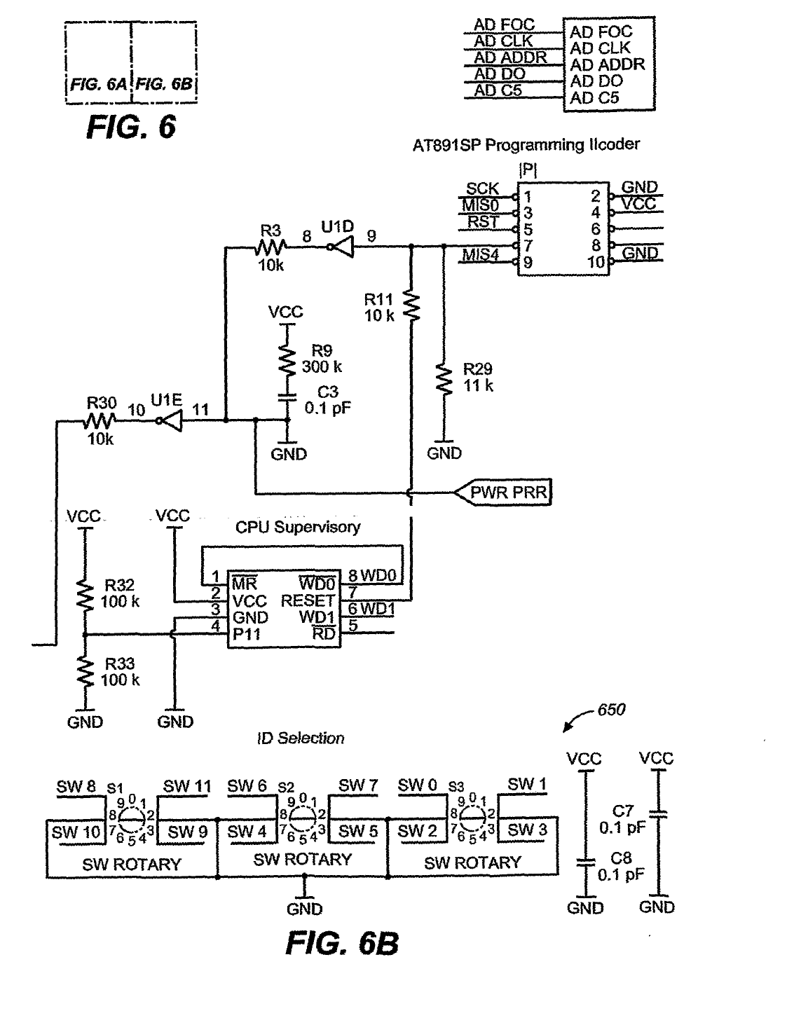

Referring to FIGS. 1 through 6, wherein like reference numerals refer to like components in the various views, there is illustrated therein a new and improved method and apparatus for array and string level monitoring of a grid-connected PV system. FIG. 1 shows in schematic form the conventional configuration of a GCPV system 10, which includes a utility power provider or grid 12, a power transmission line 14 connecting the grid to a user building power supply 16, and a current transformer 18 interposed between. The system further includes a PV power system or array 20, a power transmission line 22 extending from the PV system to a junction or meter 24 where it joins the power transmission line 14 coming from the grid, and a current transformer 26 for the PV system.

With the foregoing GCPV system configuration in mind, the inventive monitoring system comprises three primary components, including an array level monitoring component; a computer component including a programmable computer having software for obtaining, recording, and analyzing data obtained through the array level monitoring component; and a string level monitoring component.

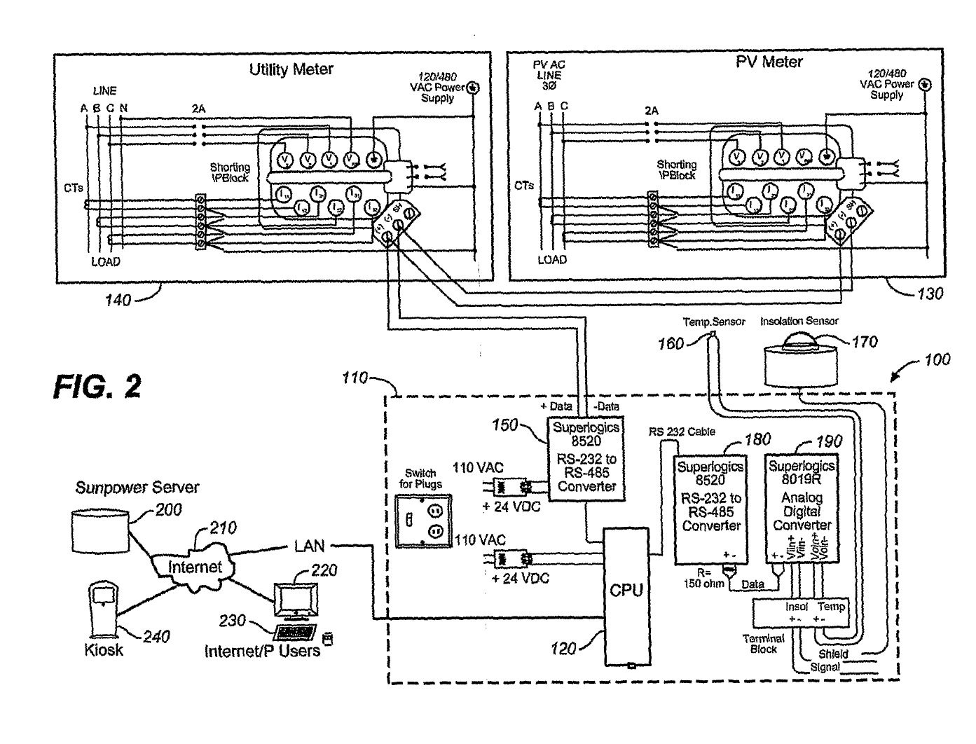

Referring now to FIG. 2, the solar power array level monitoring component 100 of the grid-connected system of the present invention includes three basic elements: (1) the back-end hardware element; (2) a server-side back-end software; and (3) a server-side front-end software.

The back-end hardware is mounted in an enclosed housing 110 that contains, among other things, a microprocessor for a small, embedded, Linux-based computer 120, such as an Open Brick platform, which preferably utilizes compact flash memory for reliability. The flash runs a Linux kernel operating system in electrical connection with revenue grade ION® 6200 power meters 130, 140. (ION® is a registered trademark of Power Measurement Ltd., of Saanichton, British Columbia, Canada.) A Superlogics 8520 RS-232 to RS-485 converter 150, is interposed between the Linux system and the power meters. The first power meter 130 measures the output of the PV system; the second power meter 140 measures power provided by the utility company. Adding the measured outputs of the meters provides an indication of user/building consumption.

The Linux computer routinely polls the meters at five second intervals to obtain readings from both the PV system meter, the utility meter, and the PV system and utility provider accumulated daily total power output. The computer also receives field measurement data collected in the operating environment. Such data may include ambient temperature data, captured by a type-J thermocouple 160 mounted in a shaded location, and solar insolation data, captured by an insolation sensor, such as an LI-200 SZ pyranometer sensor 170 mounted in the plane of the array modules. One or more AD converters 180, 190 are interposed between the computer and analog data sources, preferably including a Superlogics 8019R data acquisition interface and/or a Superlogics 8520 RS-232 to RS-485 Converter.

Accordingly, the Linux system obtains real-time data from the two power meters and the pyranometers, via AD converters, and writes a simple ASCII file having a date stamp. As a result, it stores and analyzes information concerning the photovoltaic system output (the PVKW), the PV meter system total KWH as measured from the time the meter was turned on, the PVKWH for that day, the PVKWH total for the month, the PVKWH for the year, and provides, in addition, the maximum power output for the PV system. Other fields in the ASCII file include the utility power output (in KWH), the total utility output in KWH, and other parameters, including temperature and insolation. The above-described ASCII file is logged in the event of network failure, thereby preserving an historical record that may be retrieved. Next, the file is transferred using file transfer protocol to a secure server. Additionally, the log files are regularly and automatically transferred to the server.

The back-end server is a collocated WINDOWS® 2000 server 200 located at a secure facility and in communication via the Internet 210, or other suitable telecommunications means, with the above-described Linux system. (WINDOWS® is a registered trademark of Microsoft Corporation, Redmond, Wash., US.) The back-end server runs a back-end process that reads and stores in a data directory all the files of all of the GCPV installations that have automatically uploaded files. It then makes a file in XML format for the front end. It also provides a time synchronization file, checks for errors, and performs data file housekeeping functions.

The front end of the software is a GUI 220 through which a user may login on either a conventional personal computer 230 or a computer provided at a PV vendor kiosk 240. After logging on, the user may review several animated pages based on the XML files produced by the back-end software. The first animation provides a real time screen shot showing the amount of power presently being provided by the utility company, how much power is being provided by the PV system, and how power is being consumed by the facility served. The animation includes a graphic depicting the utility grid, a power line from the grid to the building, a greatly enlarged power meter connected to the utility power line between the utility and the facility clearly showing utility power consumption (or power credit, in the event the PV system is providing more power than is being consumed by the building), a graphic of a PV solar array, a power line extending from the PV array system and intersecting and joining the power line from the utility to the building, and a graphic of the building. A simulation of this animation can presently be found at http://www.SPGsolar.com/net_metering.html.

The next element in the inventive system is the reporting software. Like the back-end engine, the front-end reporting software includes a user interface which the user logs into using a password. After logging in the user can look at the realtime data described above, or he can specify a date range in which to conduct a usage analysis. The software generates a report broken down into time intervals comprising the range. For instance, if the range is one day, the time interval is broken down into hours. If a monthly report is sought, the intervals are days. If a year report is sought, the analysis is based on monthly data. The default sub-interval is days. When a report is requested, the reporting software transmits the request to the server, which is processed by a back-end engine. The back-end engine produces the data and downloads all the data possible to view for the specified time period, such as kilowatt hours for the utility, kilowatt hours during peak, part peak, and off-peak hours, and so forth. These are based on utility provider rate schedules. On the reporting page the user is given the option of reviewing graphs as well as a spreadsheet form showing all of the data broken down by time periods. The user can collect two different parameters of building three different, building PV or utility is also the two basic parameters of KW which is power and KWH which is usage or energy.

The third component of the inventive system is the string level monitoring component. String monitoring is important because monitoring at the array level is generally limited to monitoring energy production as a function of sun time, ambient temperature, solar insolation, and so forth. But because there are so many influential factors at the array level, it is difficult to detect small device failures, as low as 1-3%, in such elements as combiner box fuses, recombiner box fuses, or individual modules at the individual string level. The string monitoring component enables monitoring at this small scale level. Detection and correction of string failures can insure the array is producing its maximum power.

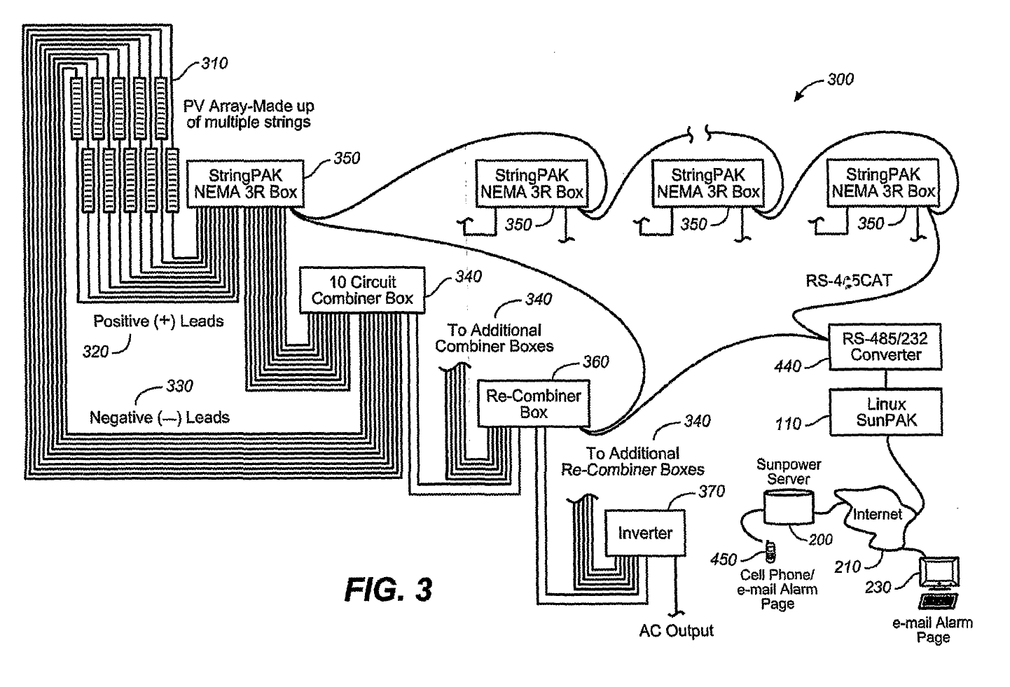

Referring now to FIG. 3, the string monitoring element 300 is in electrical communication with the PV array 310 through positive leads 320 and negative leads 330 connected to the respective ends of each series string. The leads are combined at the box level, preferably in a PCB10 PV array combiner box 340 in a NEMA 3R enclosure 350. There the output of the multiple PV source circuits are combined and the current routed through additional combiner boxes 340. In turn, all of the combiner boxes are attached to a re-combiner box 360, until the output is routed through an inverter 370.

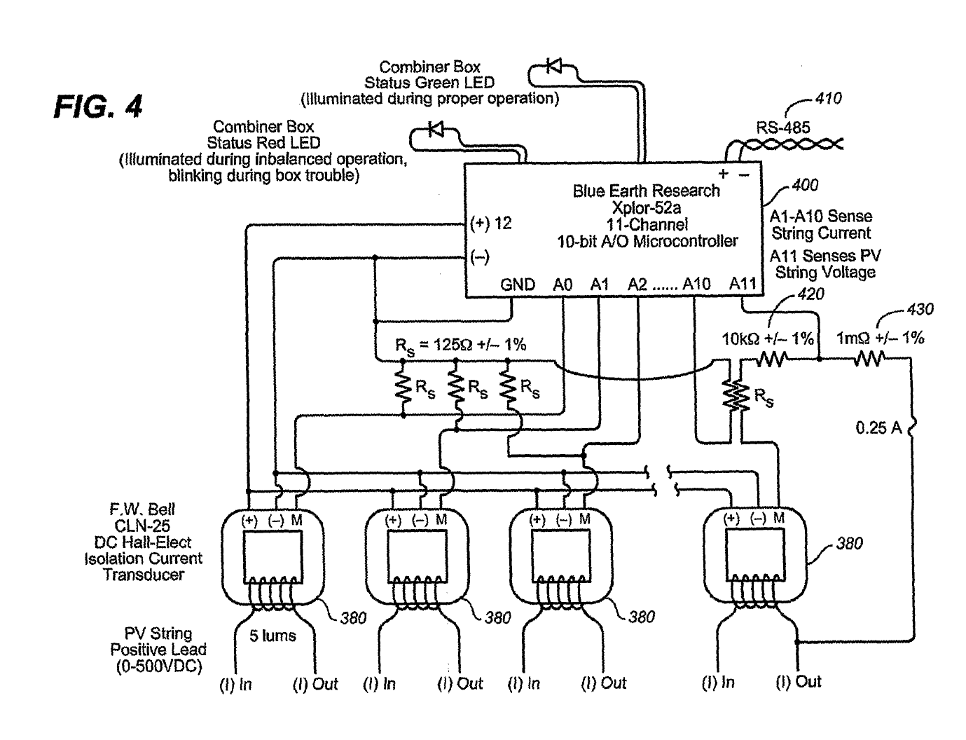

Looking now at FIG. 4, in a first preferred embodiment, the string level monitoring component employs a series of SYPRIS® CLN-25 FW Bell closed-loop current sensors 380. (SYPRIS® is a registered trademark of Sypris Solutions, Inc., of Louisville, Ky., United States.) This is a highly sensitive DC hall-effect current measuring device having one half of one percent a percent accuracy, and it is rated up to 1,000 volts DC. It functions as a transformer to step down current by several factors. The output 390 is routed into a simple micro controller 400 having an 11-channel analog to digital converter. The micro controller runs C code which supports the query language of “You Ask It” over an RS485 LAN 410. The current on each channel corresponds to the current on a respective string, and one of the channels 420 includes a resister 430 to which a voltage reference is attached. Accordingly, the combiner box electronically meters not only the current in the strings, but it also measure the voltage that operates it. Thus, the system not only measures current, but power at every single point. This provides the means to do a power balance across the array.

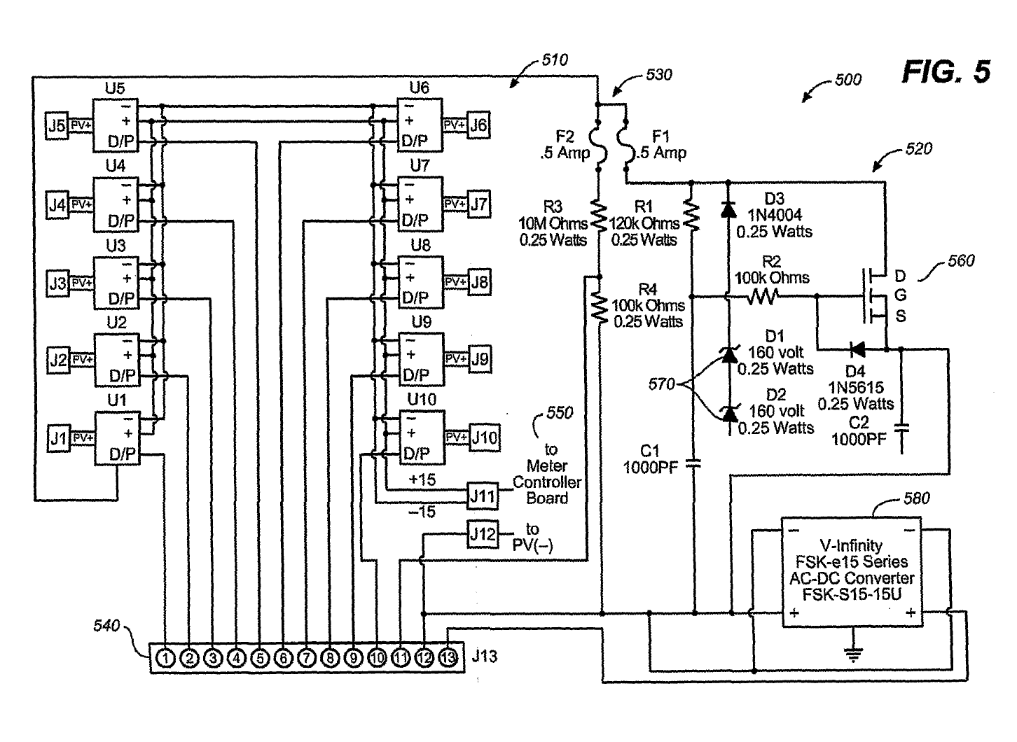

The string monitoring built into combiner boxes communicates with a co-located, on-premise central computer via RS-485 LAN 440, which is a sealed device. The central computer 110 (preferably disposed in an enclosure or housing 110 as described above) polls each of the combiner boxes, as each are addressable. They each include rotary switches set to a unique address, ranging from 0 to 999 (see FIG. 5 for switch selection circuit). The computer communicates with each combiner box with queries of the kind, “What is your string current now?” “What is your voltage now?” “What is your power on this little string?” Strings are thus individually measured and software makes analytical comparisons. If a string performs outside an acceptable range, the front end software will sound an alarm 450. By these means, very small failures in modules and fuses can be detected and addressed as necessary.

In an alternative embodiment of the string monitoring element, a sensor board 500 is provided and consists of 10 DC Hall Effect current sensors 510, a power supply 520 and a voltage divider 530. Current from the strings 540 passes through the current sensors when it is measured. The measurement signal is then sent to the micro-controller board 550. Similarly, the array voltage is sent to a high-impedance voltage divider where it is stepped down to 0-5 VDC and sent to the micro-controller board.

A unique feature of the string array monitoring system is that the custom micro-controller board is powered by the array itself, so it does not need independent power. The power supply provides the measuring electronics (the current sensor and micro-controller boards) with +15 VDC, converted from the array voltage, which is typically between 300-500 VDC. The power supply section consists of a series-pass linear FET 560 referenced by two zener diodes 570, which keep the FET output to around 300 VDC, which is the maximum input of the V-Infinity AC-to-DC converter 580, which supplies +15 VDC power to the micro-controller board.

The micro-controller board 600 in the preferred embodiment board consists of an embedded 8051-based micro-controller 610, an ADC, an RS-485, as well as other chips and components for power conditioning. The micro-controller digitizes the signals from the 10 current sensors 620 on the sensor board to obtain the 10 string currents as well as the signal from the voltage divider, which gives the string voltage level. These values are stored in memory and are sent out as ASCII byte values upon query via the RS-485 interface chip 630. Green and red LEDs 640 show proper operation and imbalanced operation, respectively. The red LED may be caused to blink to signify a specific kind of problem. As described above, the micro-controller communicates with combiner boxes through addressable combiner box ID selection switch circuits 650.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

For instance, it will be appreciated by those with skill in the art that the first two elements of the above-described system could be employed to monitor any kind of grid-connected renewable electric energy generation system. Thus, while the foregoing discussion is principally directed to grid-connected PV systems, it will be understood that the invention is also directed to providing means to monitor and analyze the performance and contribution of all types of independent renewable energy production systems, including solar, biomass, wind, geothermal, fuel cells, and hydroelectric.

Therefore, the above description and illustrations should not be construed as limiting the scope of the invention, which is defined by the appended claims.

What is claimed as invention is:

1. A system for string level monitoring of a grid-connected photovoltaic system having an array of photovoltaic solar panels, comprising:
an array level monitoring component;
a computer system in electronic communication with said array level monitoring apparatus, said computer having software and for obtaining, recording, and analyzing data from said array level monitoring system; and
a string level monitoring component in electronic communication with the array and with said computer system.

2. The system of claim 1, wherein the array level monitoring component comrpsies back-end hardware, a back end server having server-side back-end software, and a front end server having server-side front-end software.

3. The system of claim 2, wherein said back-end hardware includes a computer having a microprocessor, first and second revenue grade power meters in electrical connection with said computer, an AD converter interposed between said computer and said power meters, wherein said first power meter measures the output of the PV system; and
wherein said second power meter measures power provided by utility energy provider.

4. The system of claim 3, further including a housing for enclosing said computer.

5. The system of claim 3, wherein said computer is programmed to routinely poll said power meters at regularly spaced intervals to obtain readings from said first power meter, said second power meter.

6. The system of claim 3, further including one or more analog data sources for providing real time environmental data to said computer.

7. The system of claim 6, wherein said analog data sources include a temperature sensor.

8. The system of claim 6, wherein said analog data sources include a solar insolation sensor.

9. The system of claim 6, further including at least one AD converter interposed between said computer and said analog data sources.

10. The system of claim 6, wherein said computer is programmed to obtain real-time data from said power meters and said analog data sources, and to write a file having a date stamp.

11. The system of claim 10, wherein said computer is further programmed to store, analyze, and write a data file relating to data from the output of the photovoltaic system, including the total output of the photovoltaic meter system as measured from the time the meter was turned on, the output of the photovoltaic system for the present calendar day, the output of the photovoltaic system for the most recent month, the output of the photovoltaic system for the year, and the maximum power output for the photovoltaic system.

12. The system of claim 10, wherein said computer is further programmed to obtain, analyze, and write a file relating to data from the output of the utility power system, the total utility output for specified periods of time, and temperature and solar insolation.

13. The system of claim 10, wherein said computer is further programmed to transfer said data file to a secure server using a file transfer protocol.

14. The system of claim 13, wherein said back-end server is located at a secure facility and is in electronic communication with said computer.

15. The system of claim 14, wherein said back-end server includes back-end software that reads and stores in a data directory all the files of a plurality of grid-connected photovoltaic systems having automatically uploaded files, makes a file in a markup language format, and provides a time synchronization file, checks for errors, and performs data file housekeeping functions.

16. The system of claim 15, wherein said front end software provides a graphic user interface through which a user may log on to a computer to review screens based on the markup language files written by said back-end software, including a realtime screen shot showing the amount of power presently being provided by the utility company, how much power is being provided by the photovoltaic system, and how power is being consumed by the facility served.

17. The system of claim 16, wherein said front-end software includes means for a user to specify a date range in which to conduct an energy usage analysis, and said front-end software generates a report broken down into time intervals comprising the range.

18. The system of claim 2, wherein said string level monitoring component is in electronic communication with the array through positive leads and negative leads connected to the respective ends of each series string.

19. The system of claim 18, including a plurality of combiner boxes, and wherein said positive and negative leads are combined in a afirst array combiner box, and the output of multiple PV source circuits are combined and the current routed through additional combiner boxes.

20. The system of claim 19, further including an inverter, and wherein all of said combiner boxes are attached to a re-combiner box, and current output from said re-combiner box is routed through said inverter.

21. The system of claim 18, further including a transformer to stepdown current output from said array.

22. The system of claim 21, wherein said transformer comprises a series of closed-loop current sensors

23. The system of claim 21, wherein the output current of said transformer is routed to said micro-controller.

24. The system of claim 23, wherein said micro-controller includes a multi-channel analog to digital converter, and wherein the current on each channel corresponds to the current on a respective string, and wherein one of the channels includes a resister to which a voltage reference is attached, whereby said first combiner box meters the current in said strings and the voltage that operates it, and thus power at every single point, and whereby this provides the means to conduct a power balance across the array.

25. The system of claim 19, wherein said combiner boxes are addressable using rotary switches, and wherein said computer communicates with said combiner boxes with queries relating to string level power output data, and wherein said front-end software includes a program to emit an alarm if a string performs outside a predetermined range.

26. The system of claim 18, wherein said string level monitoring component includes a sensor board having a plurality of current sensors, a power supply, and a voltage divider.

27. The system of claim 18, wherein said micro-controller is powered by the array.
